(19) United States
(12) Patent Application Publication
(10) Pub. No.: US 2009/0234696 A1
(43) Pub. Date: Sep. 17, 2009

(54) Engineered Architecture

(76) Inventor: Eli Attia, Santa Monica, CA (US)

Correspondence Address: CARR & FERRELL LLP, 2200 GENG ROAD, PALO ALTO, CA, 94303, US

(21) Appl. No.: 12/404,263

(22) Filed: Mar. 13, 2009

Related U.S. Application Data
(60) Provisional application No. 61/069,588, filed on Mar. 17, 2008.

(51) Int. Cl. G06Q 10/00; G06Q 50/00

(52) U.S. Cl. 705/8; 700/107; 700/99

(57) ABSTRACT

Exemplary systems and methods for automated design, fabrication, and construction management. A selection concerning a building shape and a building size is received. A database is consulted to determine what design components are associated with the selected shape and size. A report is generated a building design comprising the determined design components.

### CROSS-REFERENCE TO RELATED APPLICATIONS

The present application claims the priority benefit of U.S. provisional patent application number 61/069,588 filed Mar. 17, 2008, which is entitled “EA Engineered Architecture,” the disclosure of which is incorporated herein by reference.

### BACKGROUND OF THE INVENTION

1. Field of the Invention

The present invention relates to design, fabrication, and construction. More specifically, the present invention relates to automated design, fabrication, and construction management for buildings.

2. Description of Related Art

Current practice for architectural design, fabrication, and construction for buildings includes various inefficiencies and areas of waste. Such inefficiencies may involve coordination, communication, design, material provisioning, staffing, management, etc. There is, therefore, a need in the art for improved systems and methods for automated design, fabrication, and construction management for buildings.

### SUMMARY OF THE INVENTION

Exemplary systems and methods of the present invention provide for automated design, fabrication, and construction management. A selection concerning a building shape and a building size is received. A database is consulted to determine what design components are associated with the selected shape and size. A report is generated a building design comprising the determined design components.

Various embodiments of the present invention include methods for automated design, fabrication, and construction management. Such methods include receiving selections concerning a building shape and a building size, consulting a database to determine what design components are associated with the selected building shape and the selected building size, and generating a report concerning a building design comprising the determined plurality of design components.

Various embodiments of the present invention include systems automated design, fabrication, and construction management. Such systems may include a memory for storing information concerning a plurality of building shapes and a plurality of building sizes, a communications interface of for receiving selections concerning a building shape and a building size, and a processor for determining what design components are associated with the selected building shape and the selected building size and for generating a report concerning a building design comprising the determined design components.

Some embodiments of the present invention include computer media and instructions for automated design, fabrication, and construction management.

### BRIEF DESCRIPTION OF THE FIGURES

FIG. 1A illustrates individual functionalities in current practice. FIG. 1B illustrates functionalities of practice according to exemplary embodiments of the invention.

FIG. 2A illustrates interactions of current practice. FIG. 2B illustrates interactions of practice according to exemplary embodiments of the invention.

FIG. 3 illustrates a comparison between design activity of current practice and design activity of practice according to exemplary embodiments of the invention

FIG. 4 illustrates a comparison between scope and schedule of current practice and scope and schedule of practice according to exemplary embodiments of the invention.

FIG. 5 illustrates a comparison between a timeline of current practice and a timeline of practice according to exemplary embodiments of the invention.

FIG. 6 illustrates a comparison between construction costs of current practice and construction costs of practice according to exemplary embodiments of the invention.

FIG. 7 illustrates a comparison between revenues of current practice and revenues of practice according to exemplary embodiments of the invention.

FIG. 8 illustrates a variety of building forms generated according to exemplary embodiments of the invention.

FIG. 9 illustrates a variety of building design components according to exemplary embodiments of the invention.

FIG. 10A illustrates subsets according to exemplary embodiments of the invention.

FIG. 10B illustrates a cross-section shape according to exemplary embodiments of the invention.

FIG. 10C illustrates a variety of sizes for the cross-section shape and subsets of FIGS. 10B and 10A, respectively.

FIG. 10D illustrates the different number and types of building design components.

FIG. 10E illustrates components of a subset of the cross-section shape of 10B.

FIG. 10F illustrates the circular subset of building design components.

FIG. 10G illustrates orthogonal angular subsets according to exemplary embodiments of the invention.

FIG. 10H illustrates basic subsets and major components according to exemplary embodiments of the invention.

FIG. 10I illustrates basic subsets, major components, and structure according to exemplary embodiments of the invention.

FIG. 11A illustrates a perspective view of a building design according to an exemplary embodiment of the invention.

FIG. 11B illustrates various axonometric views of a building design of FIG. 11A.

FIG. 11C illustrates various cross-sections of the building of FIG. 11A.

FIG. 11D illustrates various exteriors for the building of FIG. 11A.

FIG. 11E illustrates a few building design components in a cross-section of the building of FIG. 11A.

FIG. 11F illustrates various other building design components of the building of FIG. 11A.

FIG. 11G illustrates various floor plans and structure for the building of FIG. 11A.

FIG. 12 illustrates a group of buildings designed according to exemplary embodiments of the present invention.

FIG. 13 illustrates a group of building designed according to exemplary embodiments of the present invention.

FIG. 14 illustrates various cross-sections of a building designed according to exemplary embodiments of the present invention.

FIG. 15 illustrates two models of a building designed according to exemplary embodiments of the present invention.

FIG. 16 illustrates another building design according to an exemplary embodiment of the invention.

FIG. 17 illustrates yet another building design according to an exemplary embodiment of the invention.

FIG. 18 illustrates a variety of building shapes and associated building design components according to an exemplary embodiment of the invention.

FIG. 19 illustrates various floor plan subsets according to exemplary embodiments of the present invention.

### DETAILED DESCRIPTION

Embodiments of the present invention comprise systems and methods for automated design, fabrication, and construction management. A selection concerning a building shape and a building size is received. A database is consulted to determine what design components are associated with the selected shape and size. A report is generated a building design comprising the determined design components.

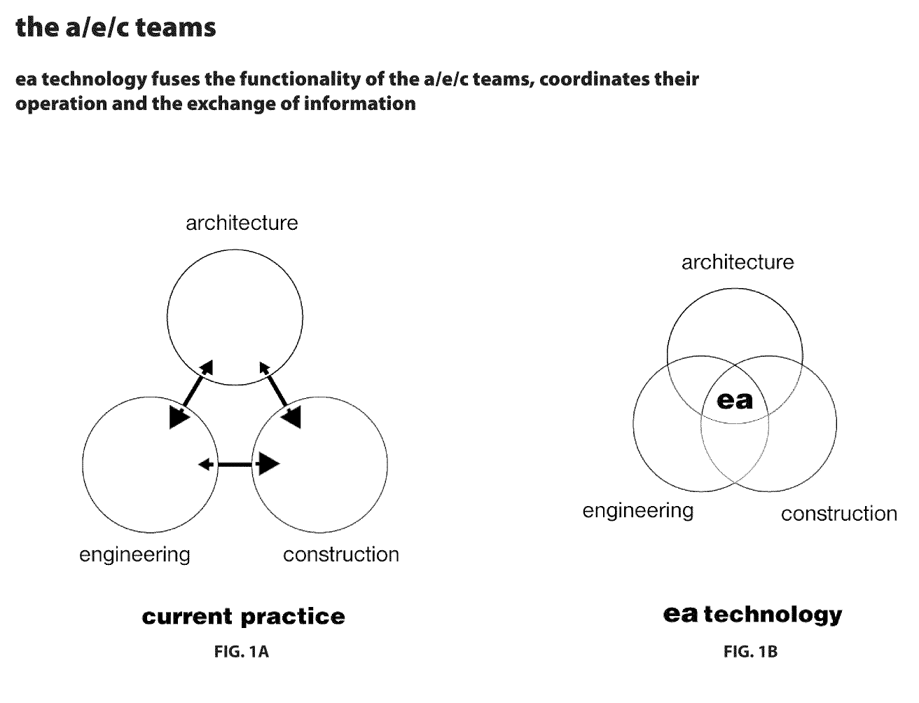

FIGS. 1A and 1B illustrate a comparison between individual functionalities in current practice and functionalities of practice according to exemplary embodiments of the invention. In current practice (FIG. 1A), the functionalities of the architect, engineer, and construction are commonly segregated. In exemplary embodiments (FIG. 1B), the method of the present invention will integrate the roles of architecture, engineering, and construction.

Such integration may create greater efficiency in the areas of design, procurement, and construction of tall and other large buildings. By changing the relationship between design, procurement, and construction, such integration will also improve on fabrication and construction processes.

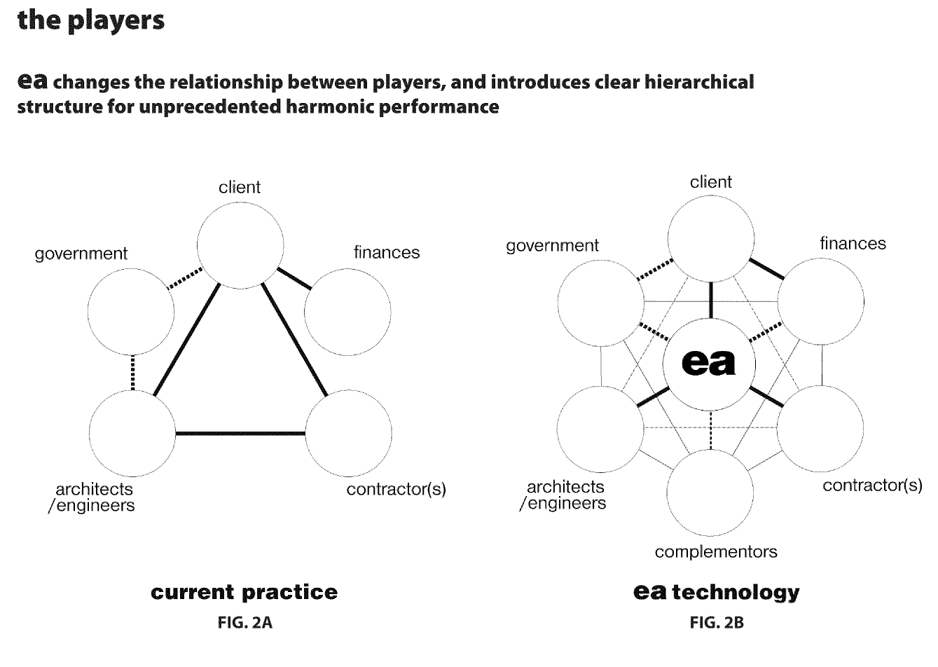

FIGS. 2A and 2B illustrate a comparison between interactions of current practice and interactions of practice according to exemplary embodiments of the invention. Current practice (FIG. 2A) may force certain patterns of communication on different parties, which may lead to various inefficiencies. In exemplary embodiments (FIG. 2B), the method of the present invention allows for communication and information to be shared among all involved parties.

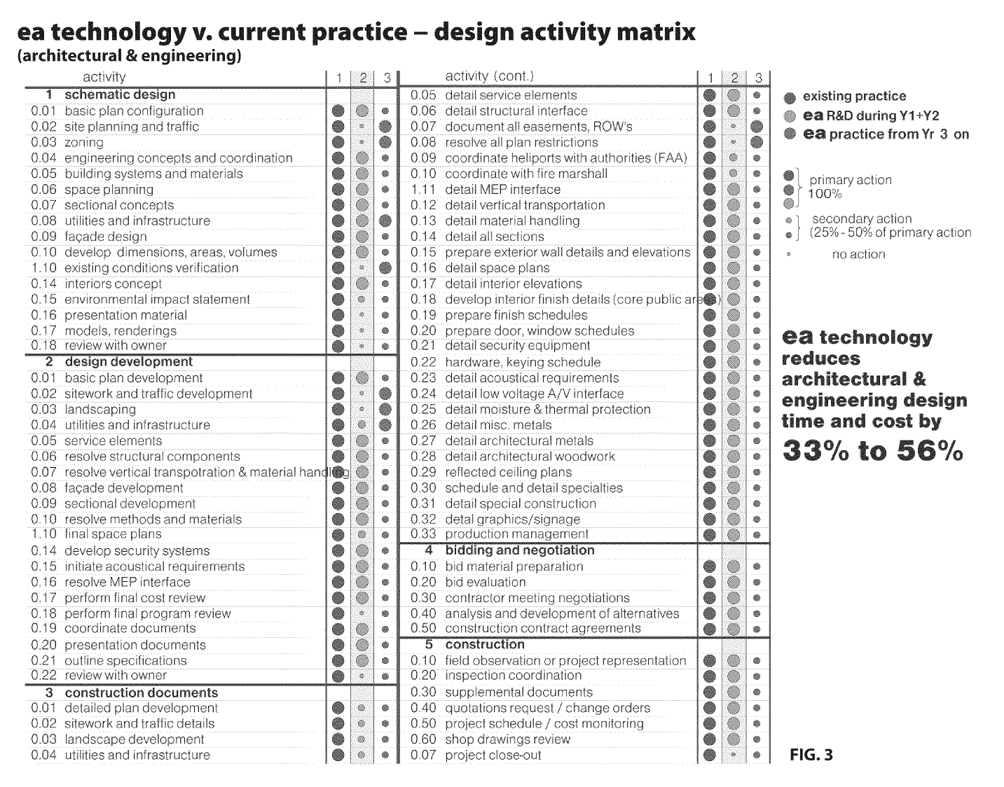

FIG. 3 illustrates a comparison between architectural and engineering activity of current practice and architectural and engineering activity of practice according to exemplary embodiments of the invention. As illustrated, embodiments of the present invention will create savings in terms of time and costs in the areas of architectural and engineering activity.

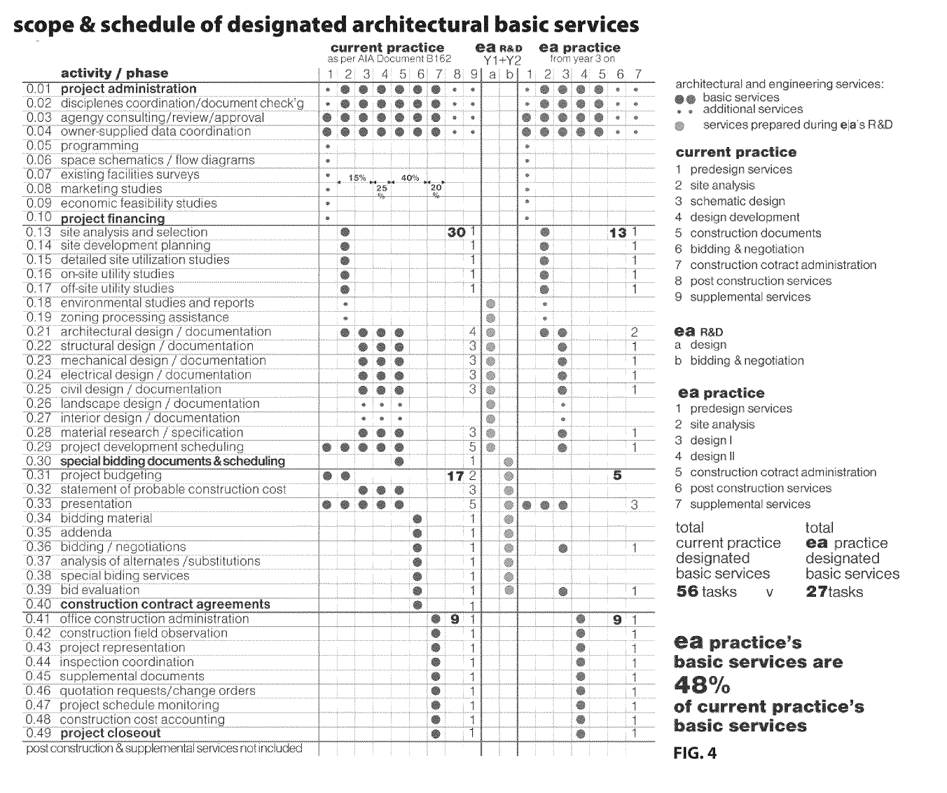

FIG. 4 illustrates a comparison between scope and schedule of current practice and scope and schedule of practice according to exemplary embodiments of the invention. Compared to current practice, embodiments of the present invention will reduce the types of architectural services required for building design.

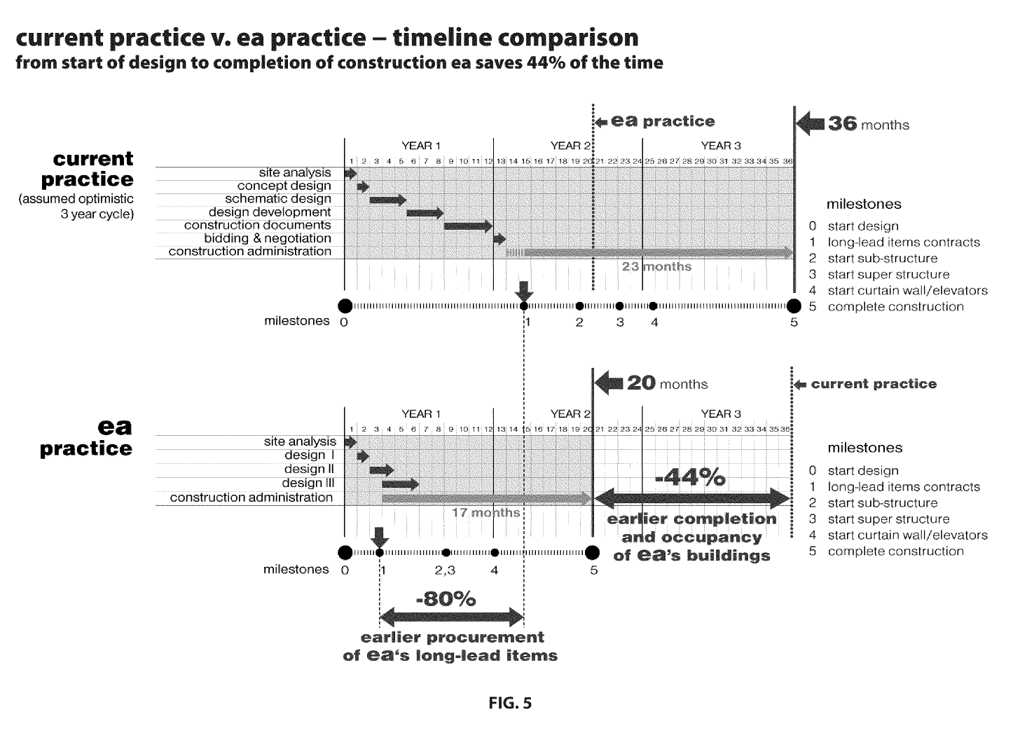

FIG. 5 illustrates a comparison between a timeline of current practice and a timeline of practice according to exemplary embodiments of the invention. As illustrated, implementation of exemplary methods of the present invention can shorten the architectural and engineering processes. Such efficiency may be created by automating the generation of design, fabrication, and construction documents, which, further, reduces or eliminates bidding wars, lag time for drawing generation, and need for extended meetings between the various design, production, and construction groups.

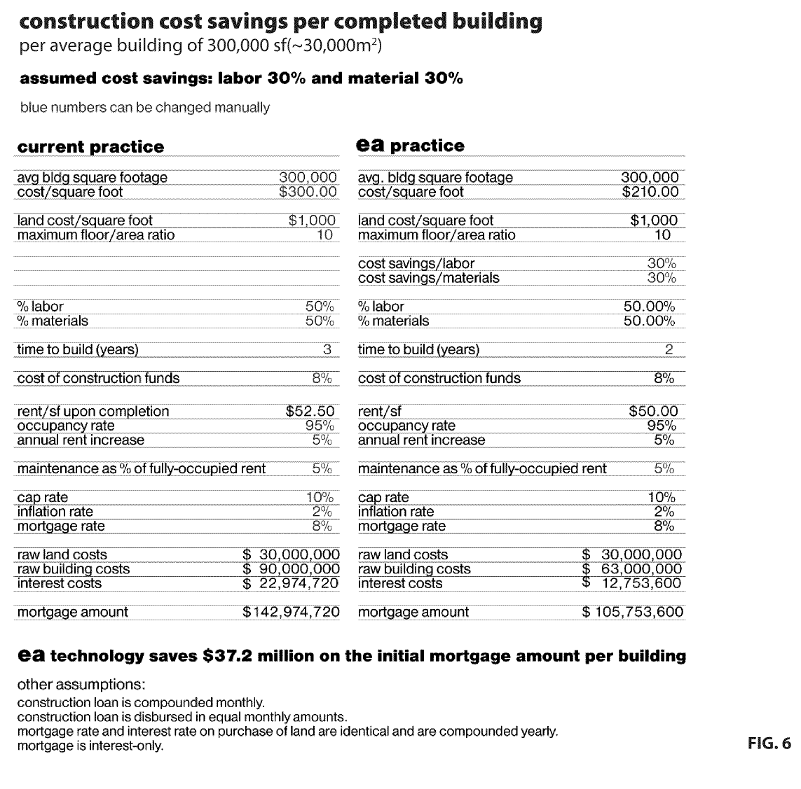

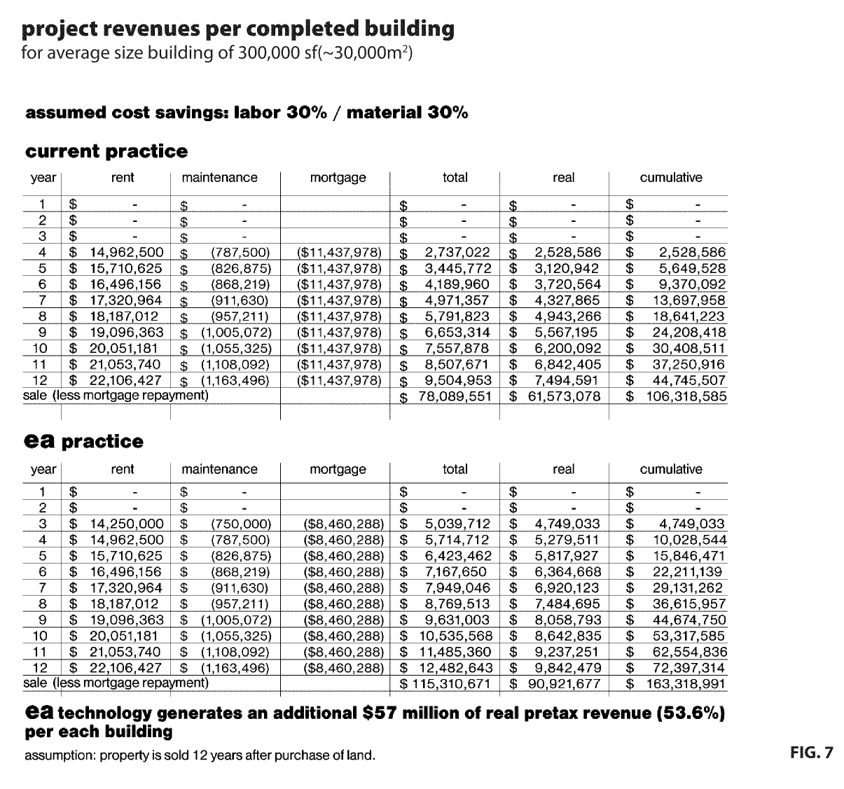

FIG. 6 illustrates a comparison between construction costs of current practice and construction costs of practice according to exemplary embodiments of the invention. Efficiency may further be created by automating the fabrication of the building components. By designing a building out of predetermined design components, orders for fabricating the physical components can be much more predictable and further allows for economies of scale. Such predictability with respect to building components also extends to on-site construction activity. For example, FIG. 7 illustrates a comparison between revenues of current practice and revenues of practice according to exemplary embodiments of the invention.

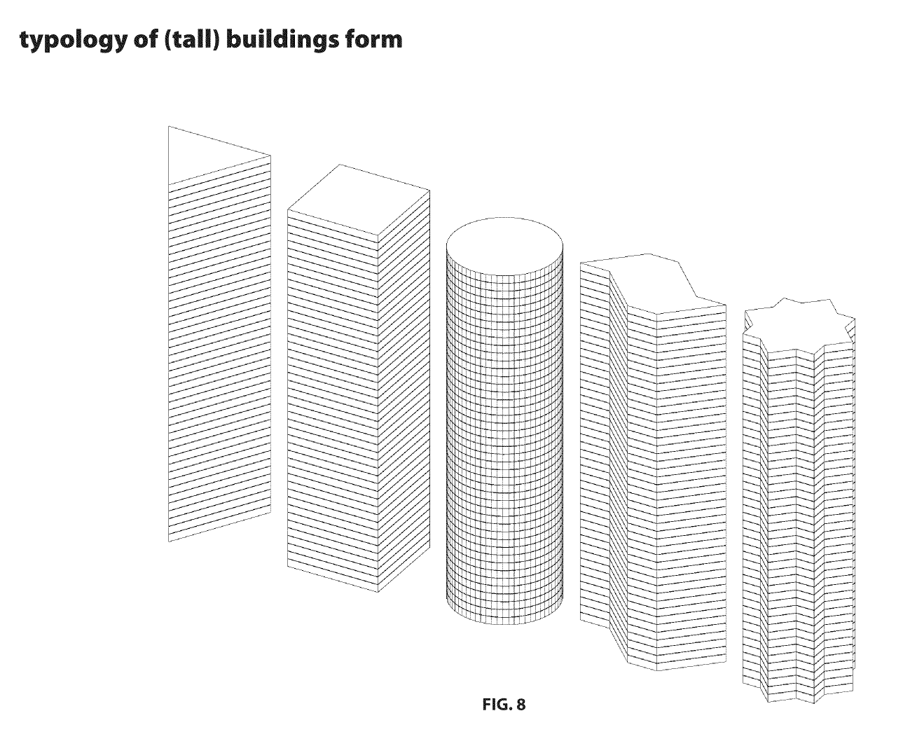

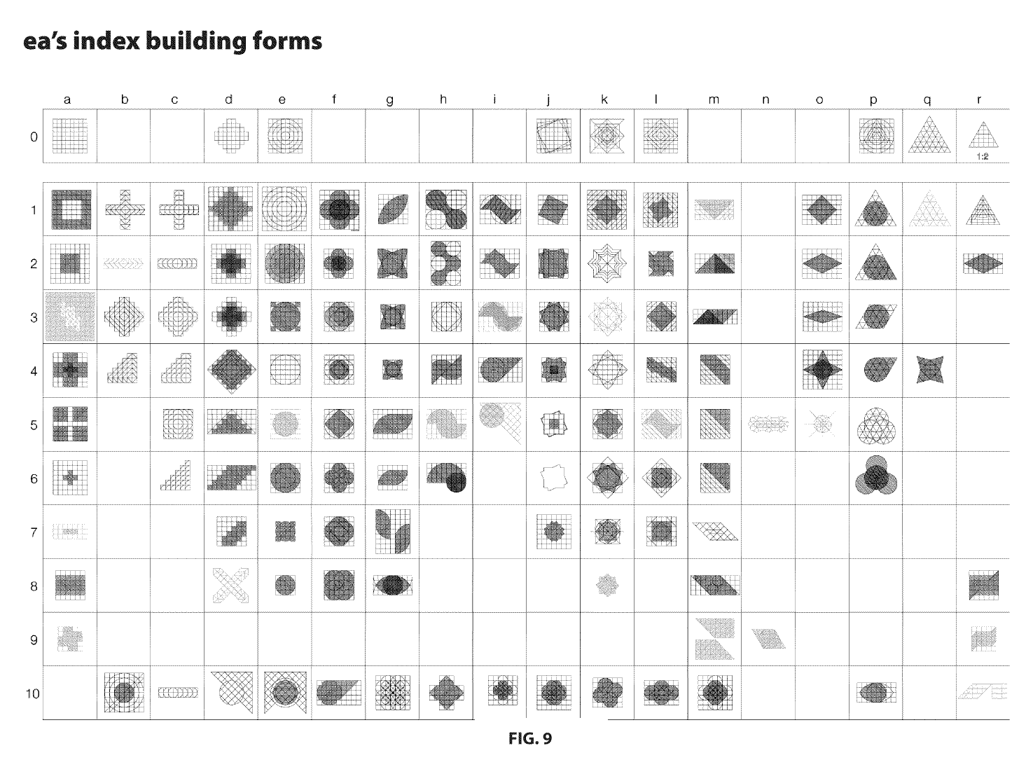

FIG. 8 illustrates a variety of building designs generated according to exemplary embodiments of the invention. With emphasis on high-level standardization and economies of scale, exemplary methods of the present invention can significantly reduce the cost of design, fabrication, and construction, as well as reducing time of construction. Such methods allow for a variety of building forms, however, as there are a variety of building design components and a variety of possible ways to use such design components. For example, FIG. 9 illustrates a variety of designs utilizing subsets (i.e., building design components) according to exemplary embodiments of the invention. The variety of design components allow for creativity in building design without sacrificing standardization and accompanying economies of scale.

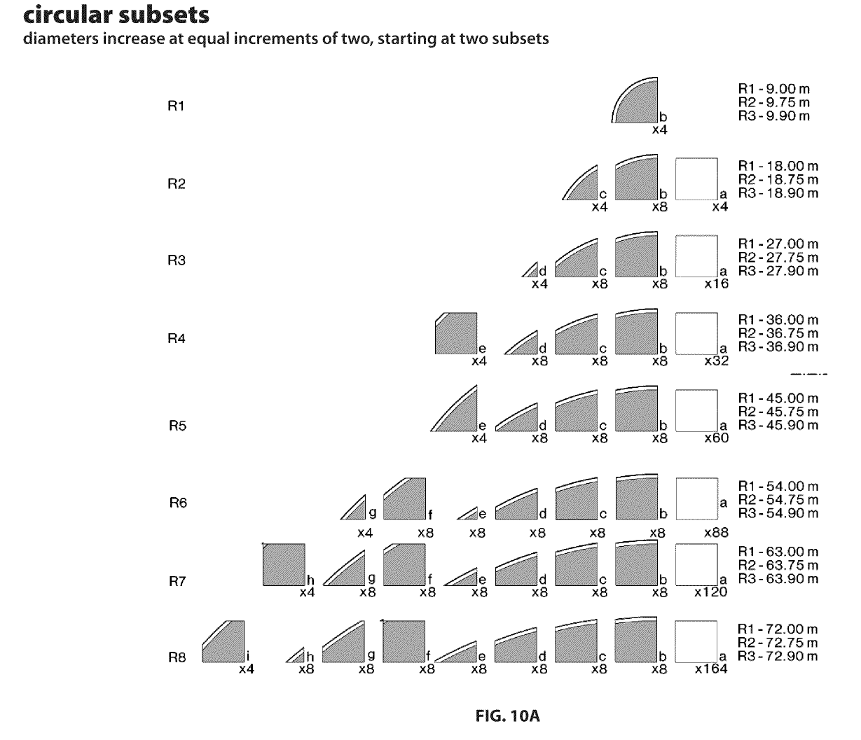

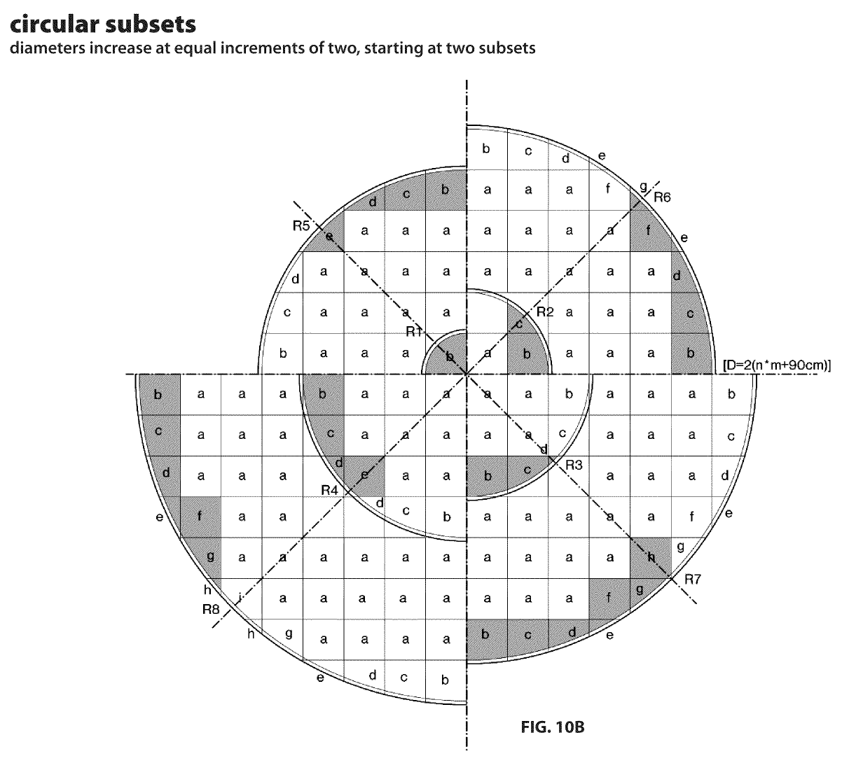

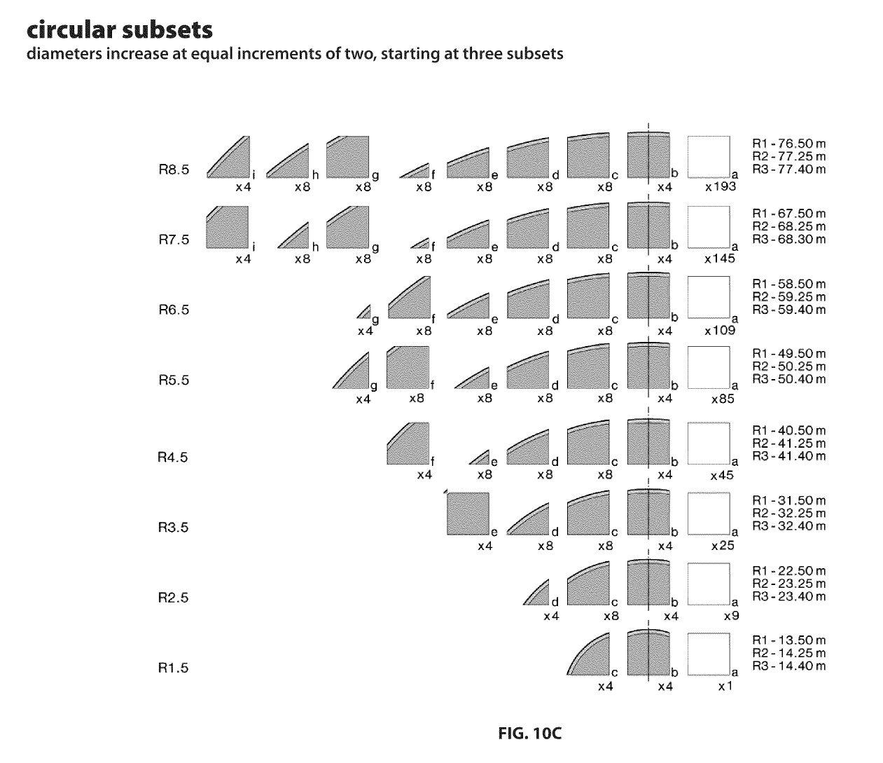

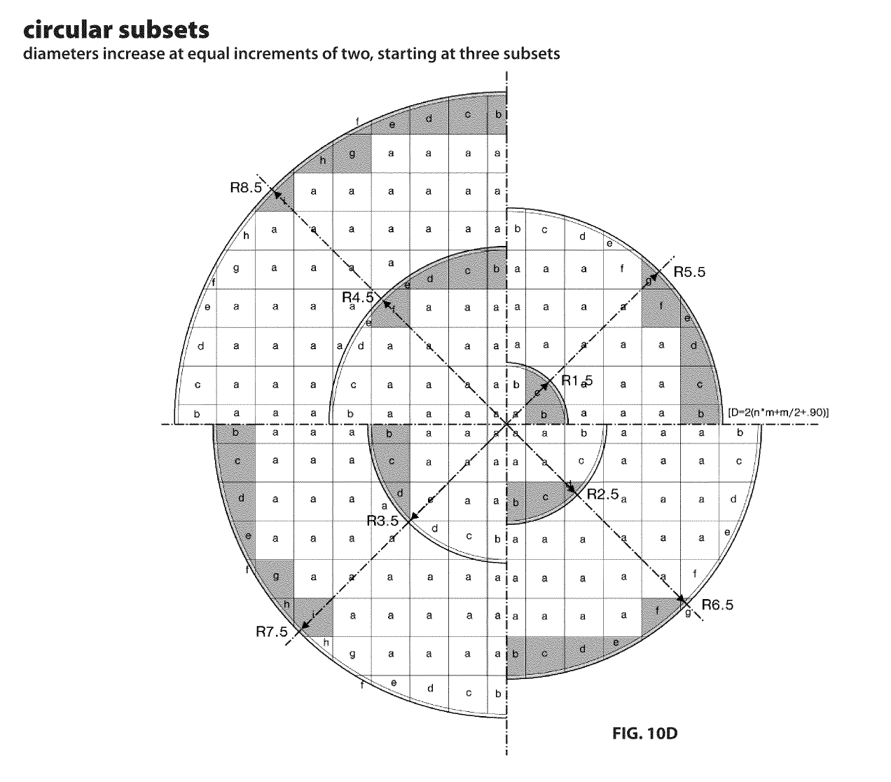

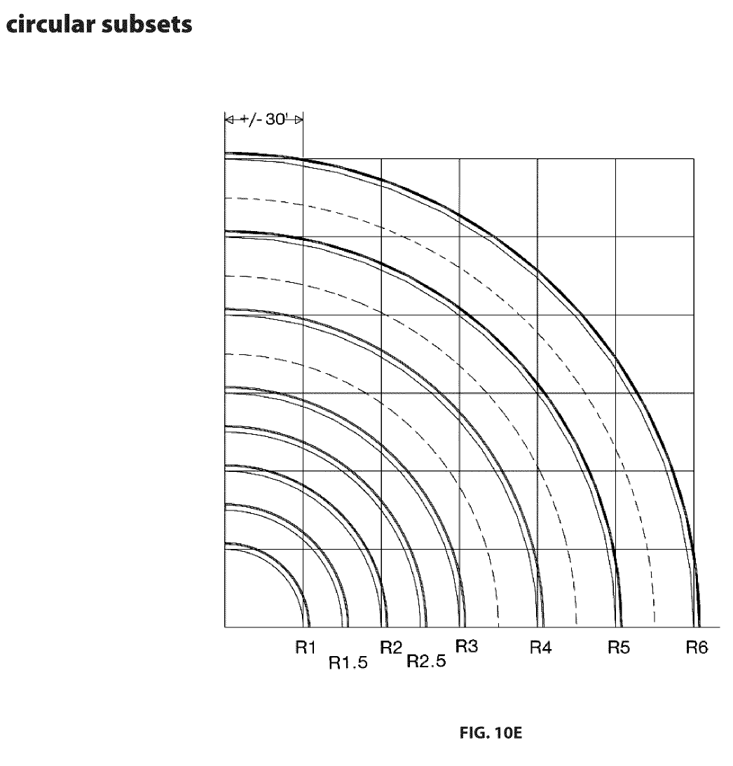

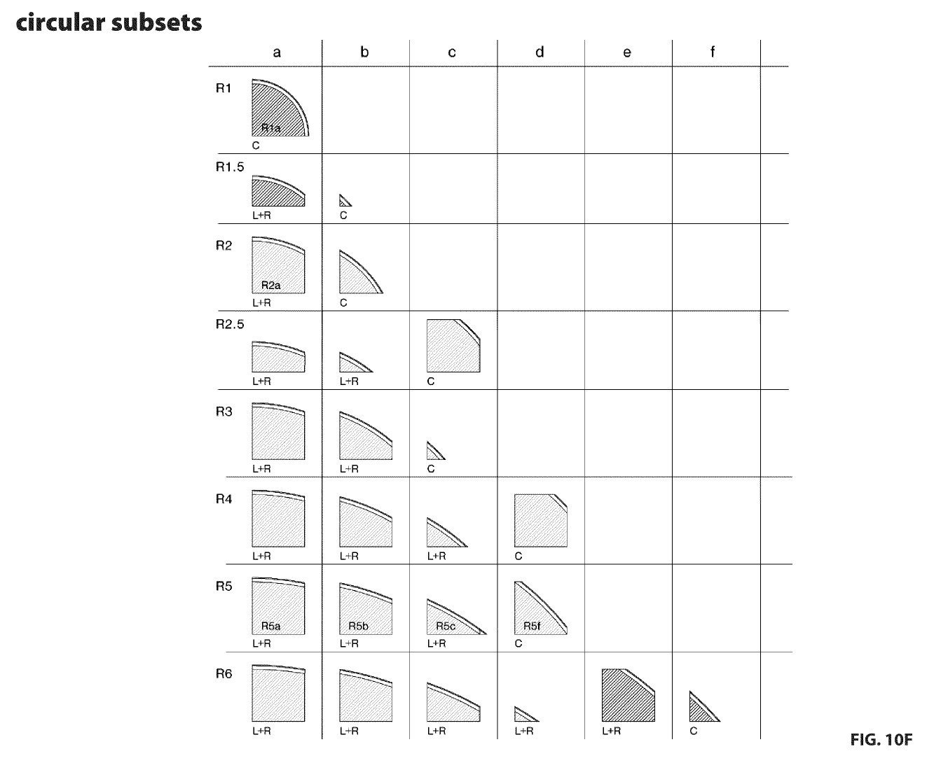

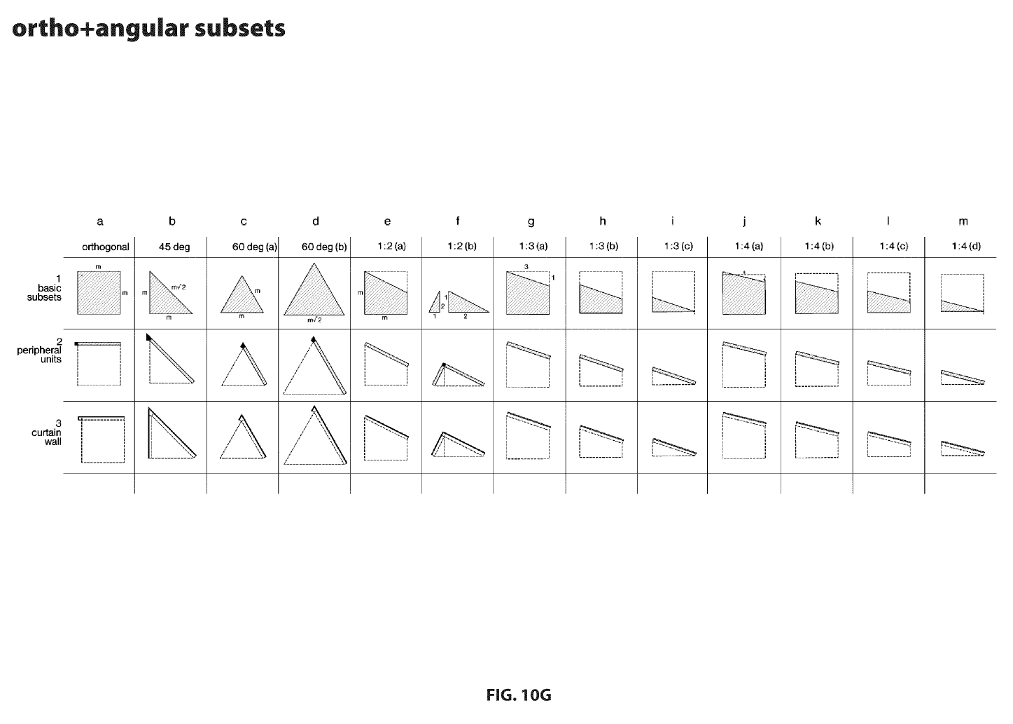

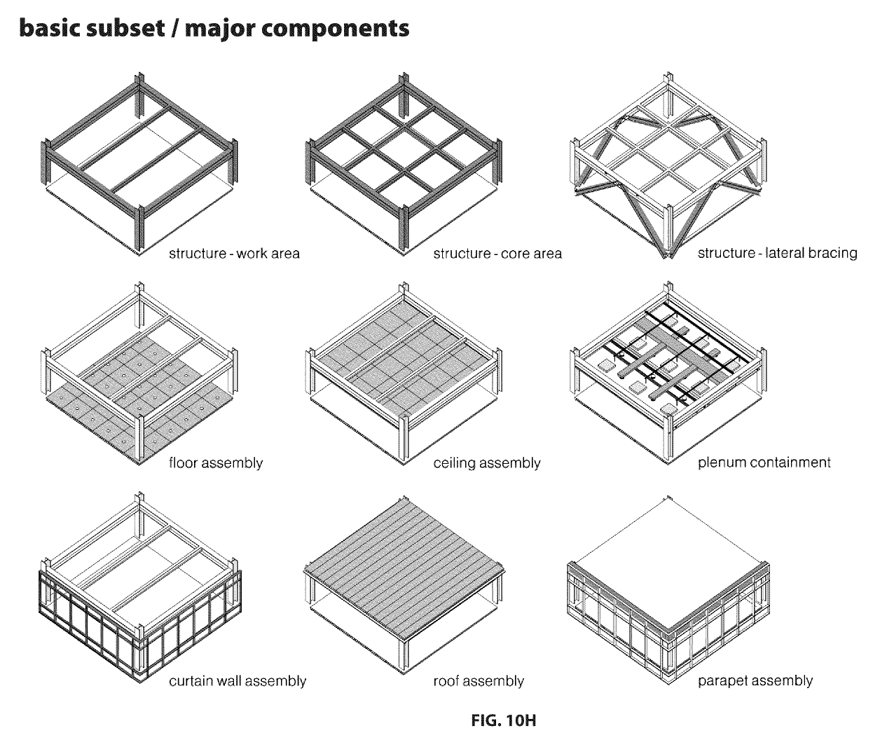

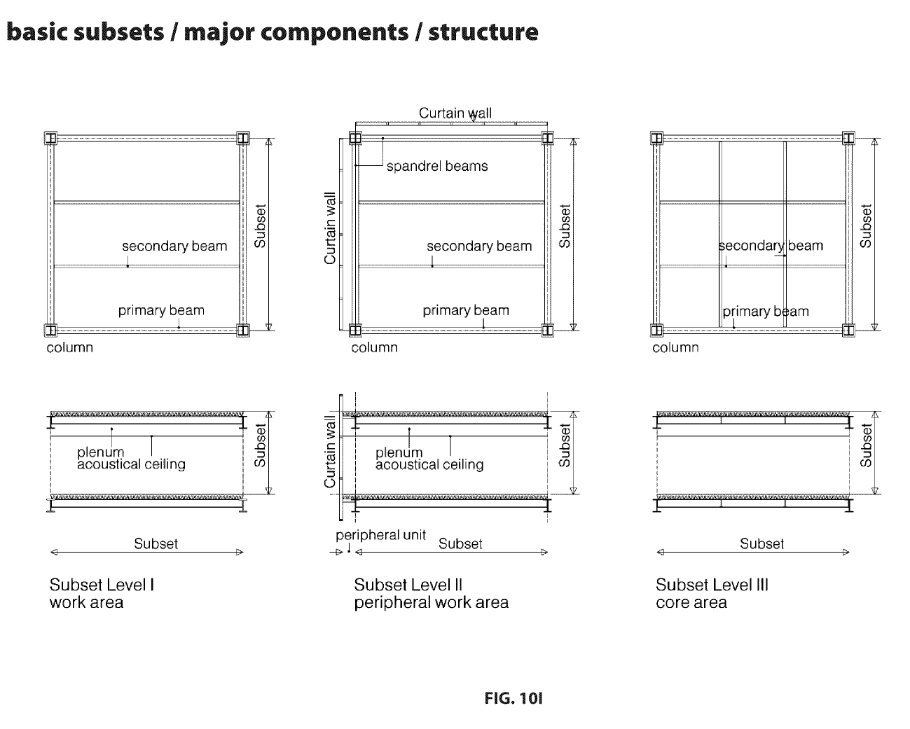

FIG. 10A illustrates subsets according to exemplary embodiments of the invention. As illustrated in FIG. 10B, the cross-section can be simplified into subsets of building design components, including those listed in FIG. 9. FIG. 10C illustrates a variety of forms and sizes for the cross-section shape and subsets of FIGS. 10B and 10A, respectively. FIG. 10D illustrates the different number and types of building design components. FIG. 10E illustrates components of a subset of the cross-section shape of 10B. FIG. 10F illustrates specifically the circular subset of building design components. FIG. 10G illustrates orthogonal and angular subsets according to exemplary embodiments of the invention. FIG. 10H illustrates basic subsets and major components according to exemplary embodiments of the invention. FIG. 10I illustrates basic subsets, major components, and structure according to exemplary embodiments of the invention.

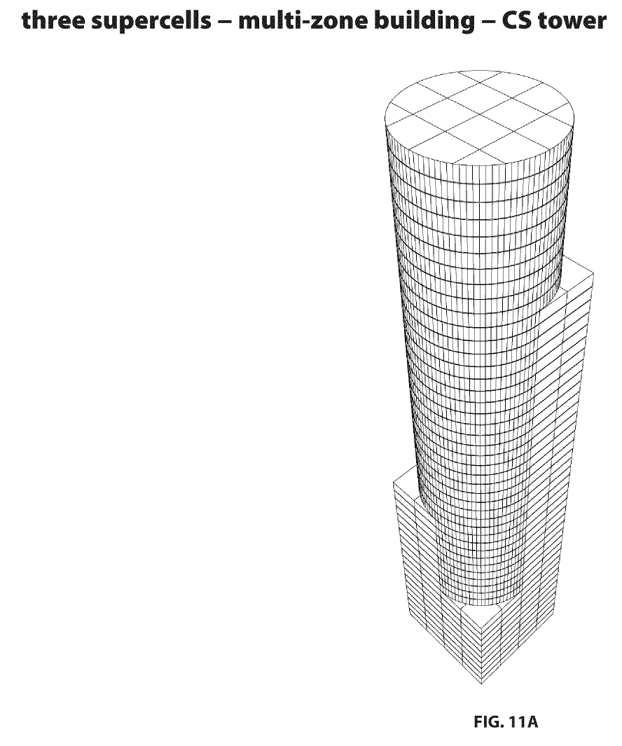

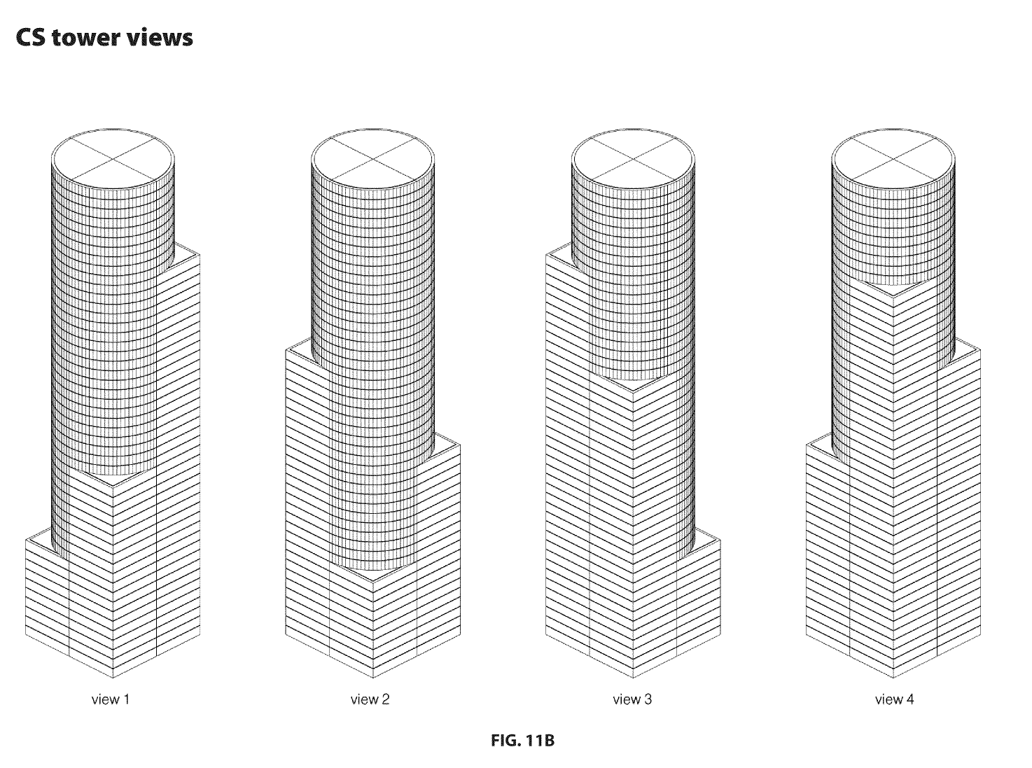

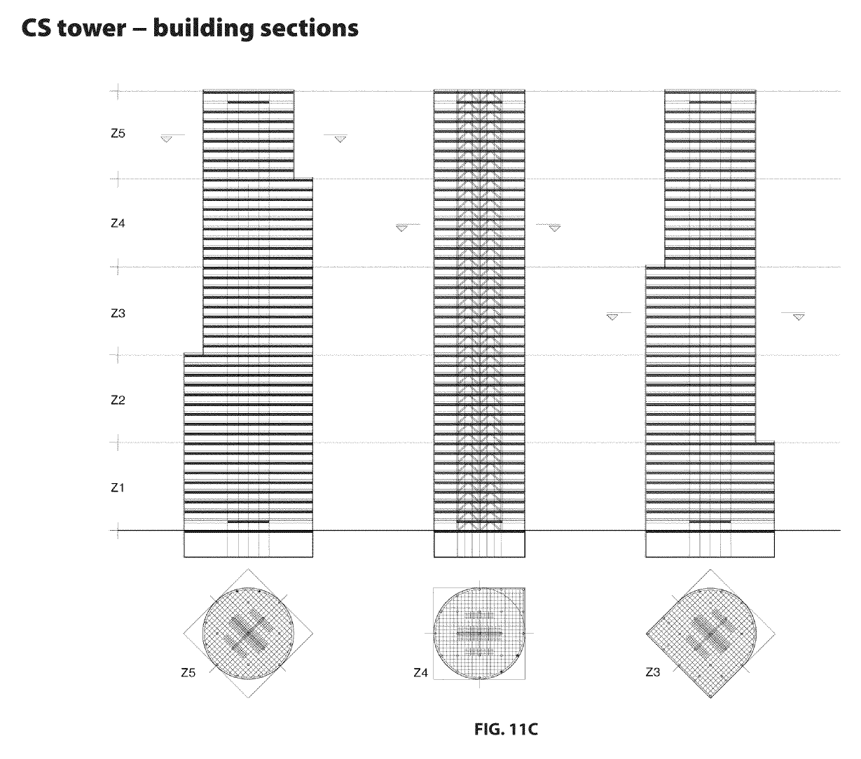

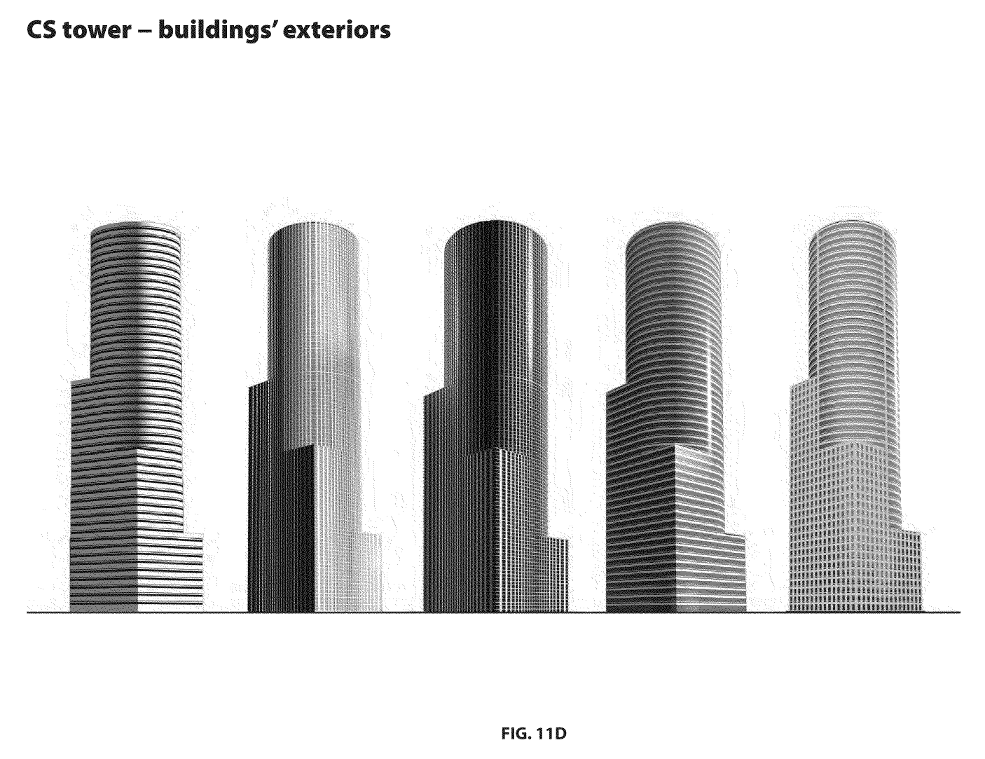

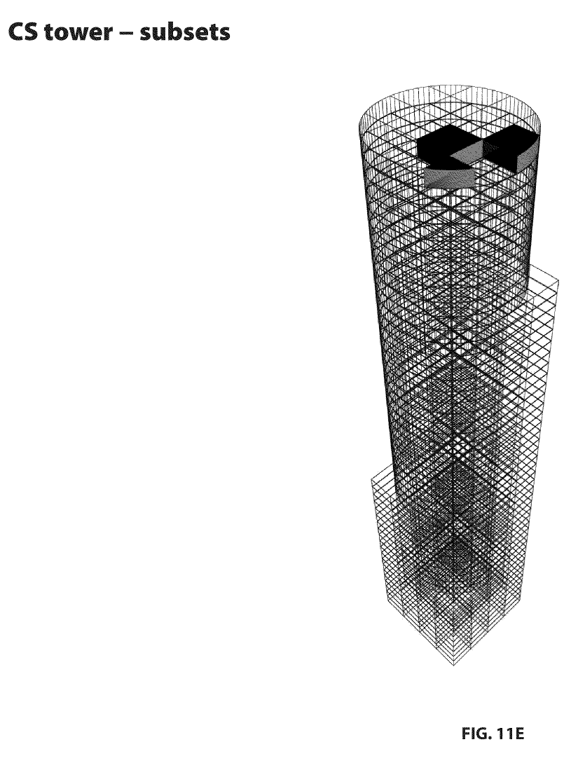

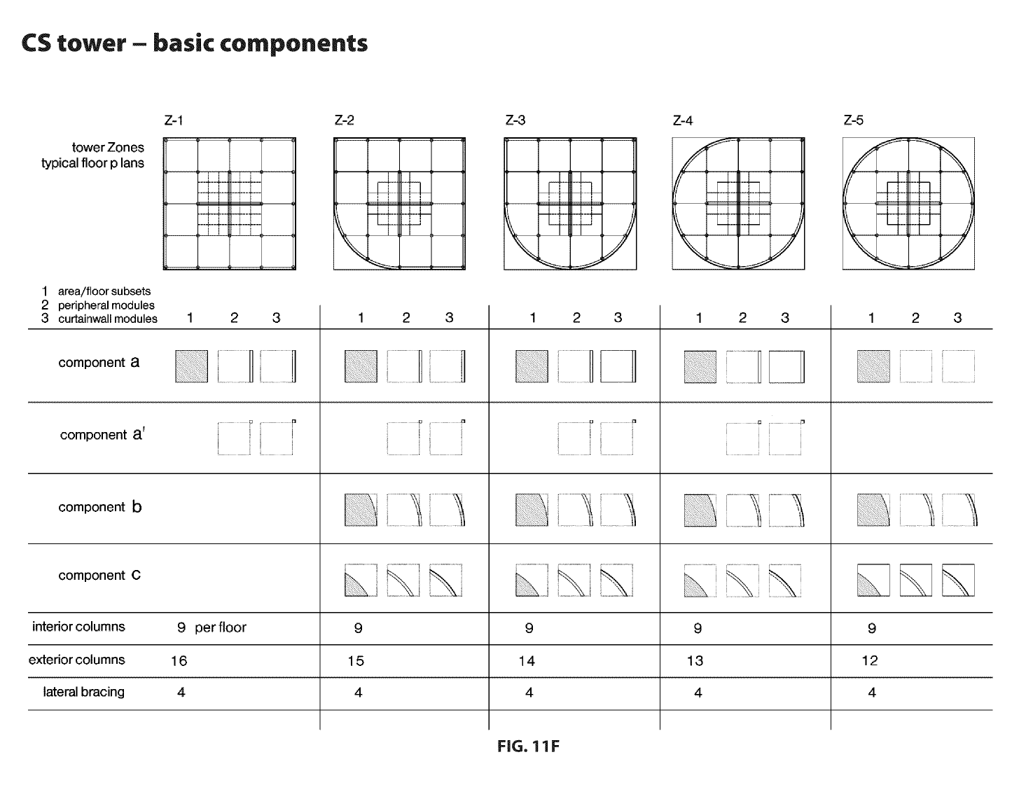

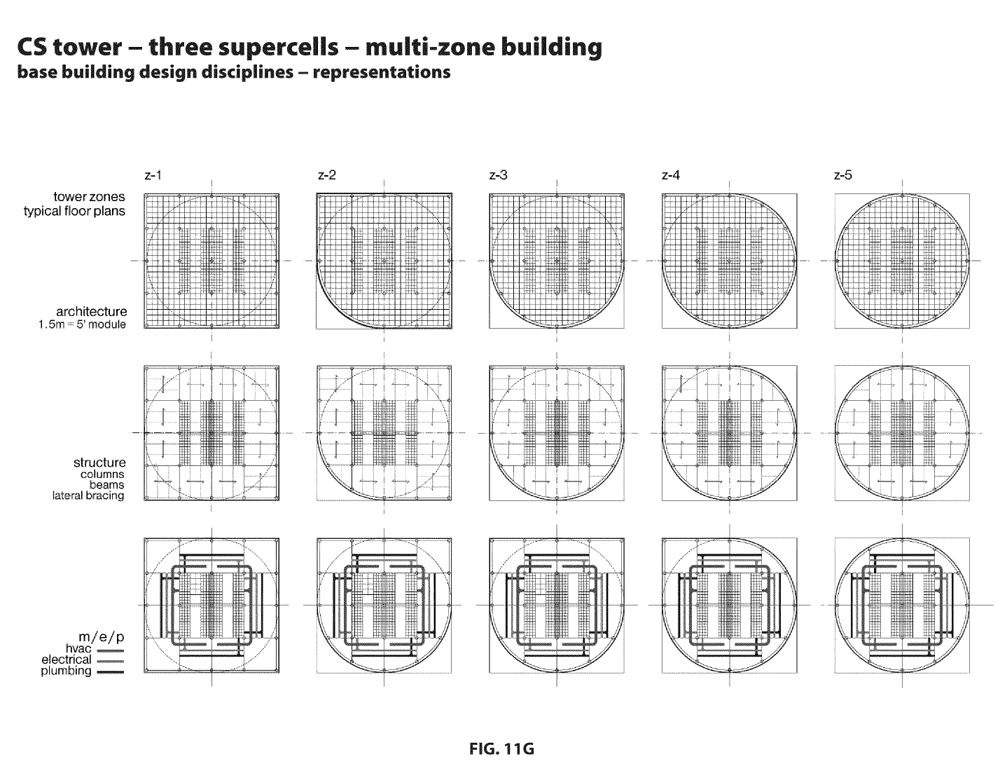

FIG. 11A illustrates a perspective view of a building design according to an exemplary embodiment of the invention. FIG. 11B illustrates various axonometric views of a building design of FIG. 11A. FIG. 11C illustrates various cross-sections of the building of FIG. 11A. FIG. 11D illustrates various exteriors for the building of FIG. 11A, according to exemplary embodiments of the invention. In a perspective view, FIG. 11E highlights a few building design subsets in a cross-section of the building of FIG. 11A. FIG. 11F illustrates various other building design components of the building of FIG. 11A. FIG. 11G illustrates various architectural, structural, and mechanical plans for the building of FIG. 11A.

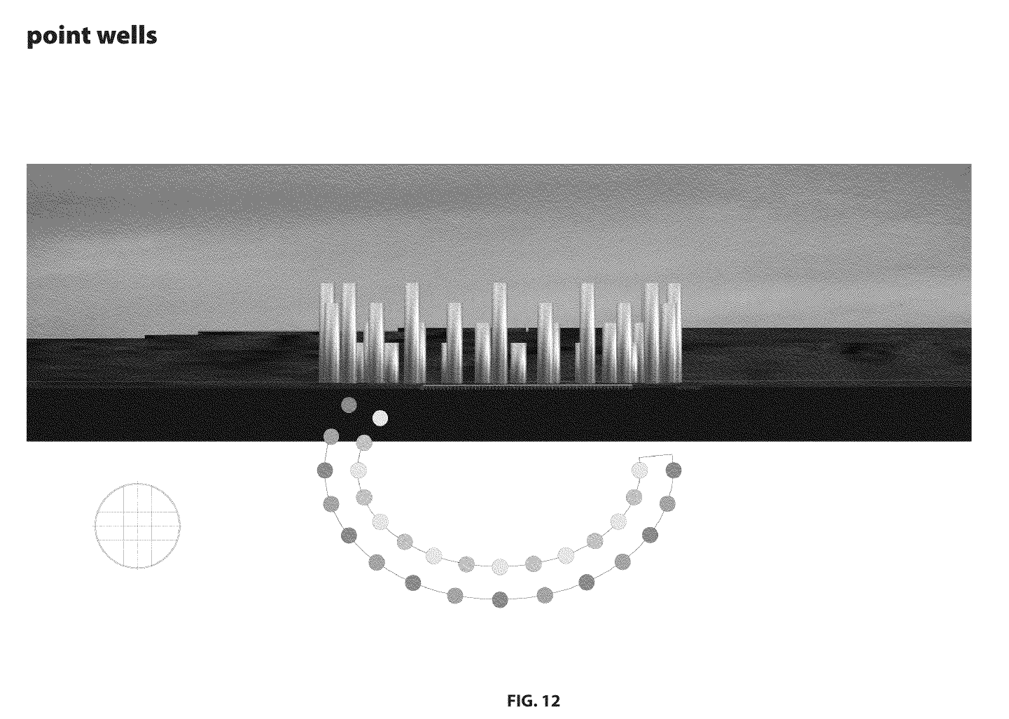

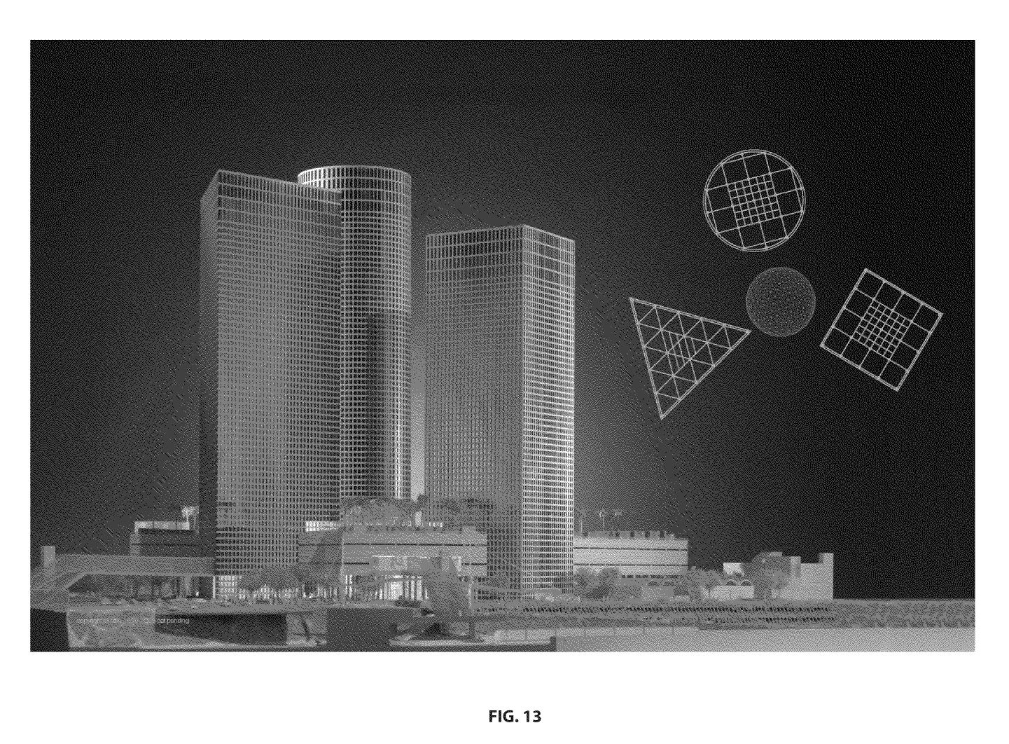

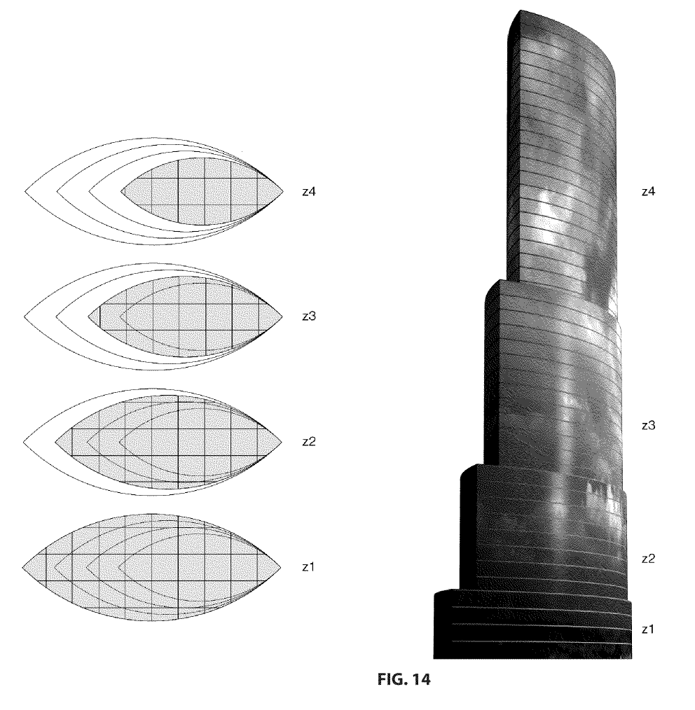

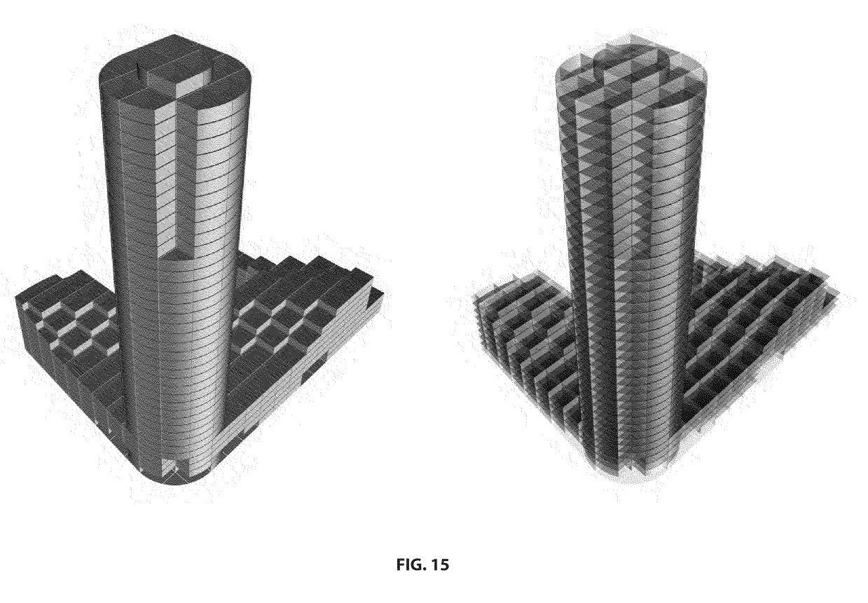

FIG. 12 illustrates a group of buildings designed according to exemplary embodiments of the present invention. FIG. 13 illustrates a group of building designed according to exemplary embodiments of the present invention. FIG. 14 illustrates various cross-sections of a building designed according to exemplary embodiments of the present invention. FIG. 15 illustrates two models of a building designed according to exemplary embodiments of the present invention.

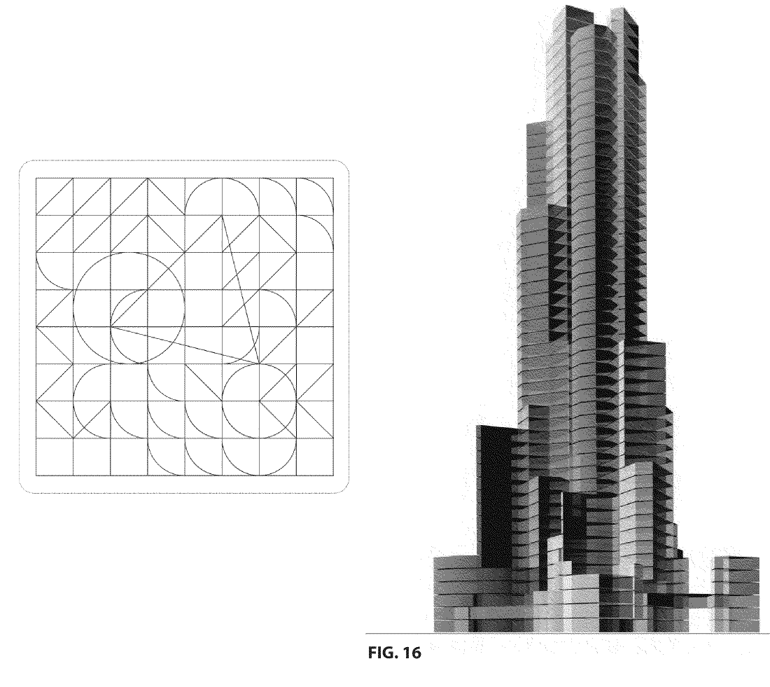

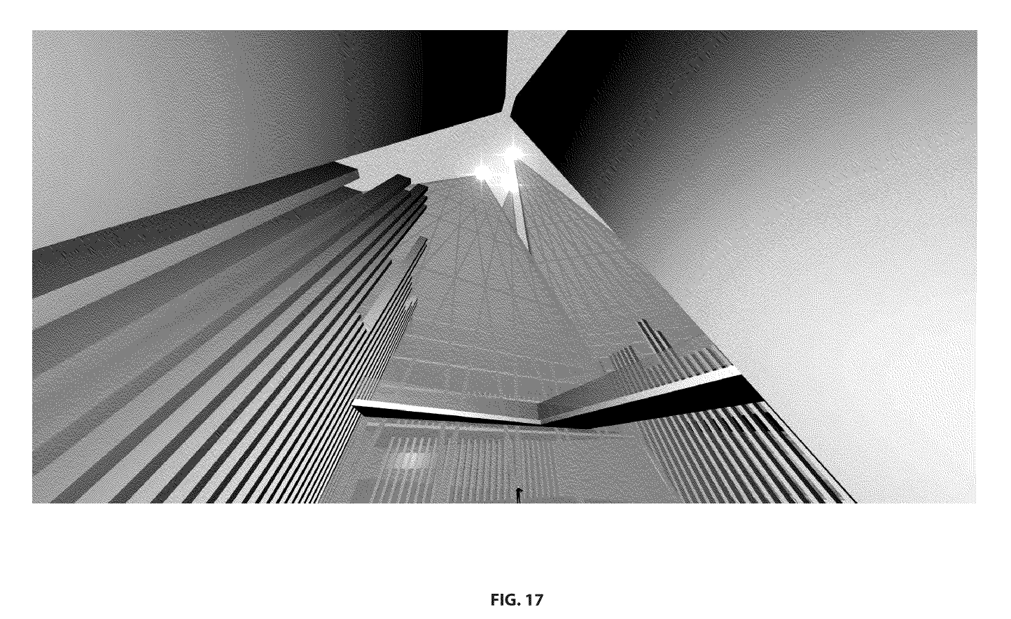

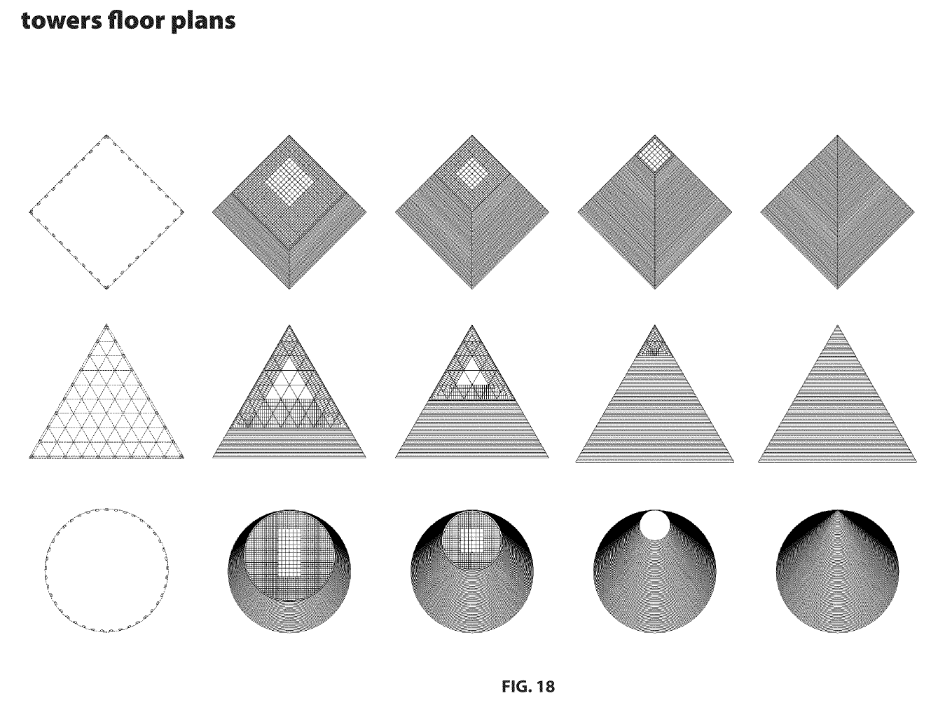

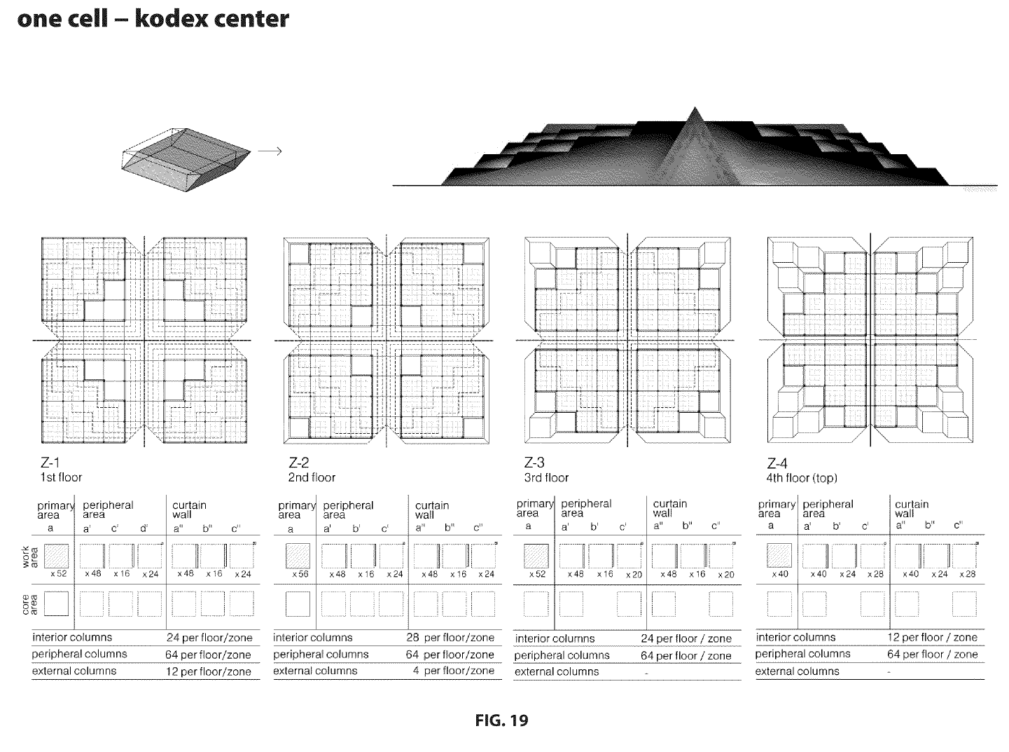

FIG. 16 illustrates another building design according to an exemplary embodiment of the invention, and FIG. 17 illustrates yet another building design according to an exemplary embodiment of the invention. FIG. 18 illustrates a variety of building shapes and associated building design components of the building of FIG. 17, according to an exemplary embodiment of the invention. Three types of three-dimensional shapes are illustrated: a pyramid with a square base, a pyramid with a triangular base, and a circular base (i.e. cone). As illustrated, such three-dimensional shapes are possible through use of the building design components. FIG. 19 illustrates various floor plan subsets according to exemplary embodiments of the present invention. FIGS. 11A-19 illustrate the variety of building designs that are possible through use of building design components according to exemplary embodiments of the invention.

Some of the above-described functions can be composed of instructions that are stored on storage media (e.g., computer-readable medium). The instructions may be retrieved and executed by the processor. Some examples of storage media are memory devices, tapes, disks, integrated circuits, and servers. The instructions are operational when executed by the processor to direct the processor to operate in accord with the invention. Those skilled in the art are familiar with instructions, processor(s), and storage media.

Any hardware platform suitable for performing the processing described herein is suitable for use with the invention. The terms “computer-readable medium” and “computer-readable media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, punch cards, paper tape, any other physical medium with patterns of marks or holes, a RAM, a PROM, an EPROM, an EEPROM, a FLASHEPROM, any other memory chip or cartridge, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents.

While the present invention has been described in connection with a series of preferred embodiment, these descriptions are not intended to limit the scope of the invention to the particular forms set forth herein. It will be further understood that the methods of the invention are not necessarily limited to the discrete steps or the order of the steps described. To the contrary, the present descriptions are intended to cover such alternatives, modifications, and equivalents as may be included within the spirit and scope of the invention as defined by the appended claims and otherwise appreciated by one of ordinary skill in the art.

What is claimed is:

1. A method of design, fabrication, and construction management, the method comprising:
receiving selections concerning a building shape and a building size; and
executing instructions stored in memory of the computing device, wherein execution of the instructions by a processor of the computing device:
consults a database configured to store information concerning a plurality of building shapes and a plurality of building sizes,
determines that a plurality of design components are associated with the selected building shape and the selected building size, and
generates a report concerning a building design comprising the determined plurality of design components.

2. A system of design, fabrication, and construction management, the system comprising:
a memory of a computing device, the memory configured to store information concerning a plurality of building shapes and a plurality of building sizes;
a communications interface of the computing device, the communications interface configured to receive selections concerning a building shape and a building size; and
a processor of the computing device, the processor configured to execute instructions stored in memory to
consult a database configured to store information concerning a plurality of building shapes and a plurality of building sizes,
determine that a plurality of design components are associated with the selected building shape and the selected building size, and
generate a report concerning a building design comprising the determined plurality of design components.

3. A computer-readable storage medium, having embodied thereon a program, the program being executable by a processor to perform a method for design, fabrication, and construction management, the method comprising:
receiving selections concerning a building shape and a building size; and
executing instructions stored in memory of the computing device, wherein execution of the instructions by a processor of the computing device:
consults a database configured to store information concerning a plurality of building shapes and a plurality of building sizes,
determines that a plurality of design components are associated with the selected building shape and the selected building size, and
generates a report concerning a building design comprising the determined plurality of design components.
